(19) United States
(12) Patent Application Publication
(10) Pub. No.: US 2025/0332783 A1
(43) Pub. Date: Oct. 30, 2025

(54) Movable Carriage and Wrapping a Material Sheet Around a Longitudinal Component

(71) Applicants: The Boeing Company, Arlington, VA (US); University of Washington, Seattle, WA (US)

(72) Inventors: Riley Michael Sharman, Seattle, WA (US); Aaron Weber, Seattle, WA (US); Andrew Lam Nguyen, Renton, WA (US); James Guo, Seattle, WA (US); Michael Hoyan Wan, Houston, TX (US); Keegan David Bray, Seattle, WA (US); Asher Seth Einhorn, Seattle, WA (US); Lance Oliver McCann, Tukwila, WA (US); Shuonan Dong, Seattle, WA (US); Santosh Devasia, Seattle, WA (US); Joe Garbini, Seattle, WA (US)

(21) Appl. No.: 18/651,347

(22) Filed: Apr. 30, 2024

(51) Int. Cl. B29C 63/04; B29C 63/00; B29L 31/00

(52) U.S. Cl. CPC B29C 63/04; B29C 63/0004; B29C 2063/0008; B29L 2031/003

(57) ABSTRACT

A movable carriage configured to wrap a material sheet around a longitudinal component is presented. The movable carriage comprises a frame defining a center plane and an operating volume; side wheels within the operating volume configured to guide the material sheet against sides of a portion of the longitudinal component, when disposed within the operating volume and aligned with the center plane, as the movable carriage moves parallel to the center plane, the side wheels arranged as one or more opposing pairs about the center plane; and top wheels within the operating volume configured to guide the material sheet against the top of the portion of the longitudinal component as the movable carriage moves parallel to the center plane, the top wheels arranged as one or more opposing pairs about the center plane.

### BACKGROUND INFORMATION

### 1. Field

The present disclosure relates generally to a movable carriage and methods for wrapping a material sheet around a longitudinal component.

### 2. Background

In manufacturing processes, a material sheet can be wrapped around a component for a variety of reasons, for example to provide desired surface properties and/or functionality during manufacturing. Accordingly, some material sheets can take the form of a breather or a release film. Material sheets can also be wrapped around a manufacturing tool or a product.

Therefore, it would be desirable to have a method and apparatus that takes into account at least some of the issues discussed above, as well as other possible issues. It would be desirable to at least one of more easily or more quickly wrap a material sheet around a component.

### SUMMARY

Embodiments of the present disclosure provide a movable carriage configured to wrap a material sheet around a longitudinal component, for example when the longitudinal component is placed, disposed, or otherwise arranged on the material sheet. An embodiment of the present disclosure provides a movable carriage configured to wrap a material sheet around a longitudinal component placed on the material sheet. The movable carriage comprises a frame defining a center plane and an operating volume, side wheels within the operating volume configured to guide the material sheet against sides of a portion of the longitudinal component when disposed within the operating volume and aligned with the center plane, as the movable carriage moves parallel to the center plane, and top wheels within the operating volume configured to guide the material sheet against the top of the portion of the longitudinal component as the movable carriage moves parallel to the center plane. The side wheels are arranged as one or more opposing pairs about the center plane. The top wheels are arranged as one or more opposing pairs about the center plane.

Another embodiment of the present disclosure provides a movable carriage configured to wrap a material sheet around a longitudinal component. The movable carriage comprises a frame with a center plane, top, and sides; a movement system connected to the sides of the frame; side wheels connected to the frame, and top wheels connected to the frame. The movement system is configured to move the movement of the movable carriage in a movement direction parallel to the center plane. The side wheels comprise a first side wheel pair symmetric about the center plane, and a second side wheel pair symmetric about the center plane and offset from the first side wheel pair along the center plane. The top wheels comprise a first top wheel pair symmetric about the center plane and angled away from each other at a first angle, and a second top wheel pair symmetric about the center plane and angled away from each other at a second angle.

A further embodiment of the present disclosure provides a movable carriage configured to wrap a material sheet around a longitudinal component. The movable carriage comprises a frame defining a center plane and an operating volume; a plurality of wheels within the operating volume arranged as a plurality of stages offset from each other along the center plane of the frame, wherein angles of wheels of each respective stage of the plurality of stages increase along the center plane; and a number of positioning plates connected to the frame and holding the plurality of wheels normal to a cross-sectional shape of the longitudinal component.

Yet another embodiment of the present disclosure provides a method of wrapping a material sheet around a longitudinal component. A movable carriage is positioned such that a longitudinal component is within an operating volume beneath a frame of the movable carriage. The movable carriage is moved in a direction parallel to a longitudinal axis of the longitudinal component. The material sheet is guided around the longitudinal component using wheels of the movable carriage within the operating volume as the movable carriage moves in the direction.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a cross-sectional view of a longitudinal component with a plurality of material sheets in accordance with an illustrative embodiment;

FIG. 4 is an illustration of an isometric view of a movable carriage applying a material sheet around a longitudinal component in accordance with an illustrative embodiment;

FIG. 5 is an illustration of a top view of a movable carriage applying a material sheet around a longitudinal component in accordance with an illustrative embodiment;

FIG. 6 is an illustration of a front cross-sectional view of a movable carriage applying a material sheet around a longitudinal component in accordance with an illustrative embodiment;

FIG. 7 is an illustration of a side view of a movable carriage applying a material sheet around a longitudinal component in accordance with an illustrative embodiment;

FIG. 8 is a flowchart of a method of wrapping a material sheet around a longitudinal component in accordance with an illustrative embodiment;

FIG. 9 is an illustration of an aircraft manufacturing and service method in a form of a block diagram in accordance with an illustrative embodiment; and

FIG. 10 is an illustration of an aircraft in a form of a block diagram in which an illustrative embodiment may be implemented.

### DETAILED DESCRIPTION

The illustrative examples recognize and take into account several considerations. The illustrative embodiments recognize and take into account that during airplane fabrication, pressurized rubber bladders can be used inside stringer cavities to provide reaction and compaction forces to the un-cured composite bodies. The illustrative embodiments recognize and take into account that before use, bladders can be wrapped with layers of material to provide release or other manufacturing support.

The illustrative embodiments recognize and take into account that conventional bladder wrapping is performed by hand. During manual bladder wrapping the bladder is moved to a workstation using a gantry and the operator wraps each layer and tapes it by hand. The illustrative embodiments recognize and take into account that the manual process can take several hours. The illustrative embodiments recognize and take into account that it can be undesirably difficult to consistently apply the desired amount of tension over the length of the longitudinal component to prevent wrinkles.

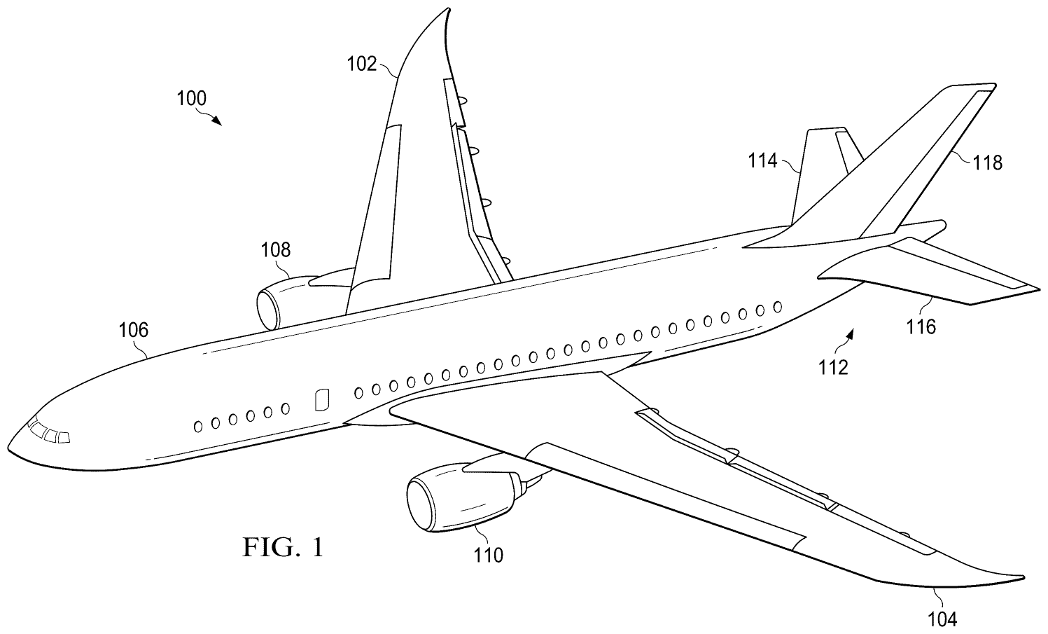

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

In some illustrative examples, components of aircraft 100 can be manufactured using longitudinal components wrapped using at least one of the movable carriage or disclosed methods. The movable carriage of the illustrative examples can be used to wrap a longitudinal component in manufacturing a component of aircraft 100. Aircraft 100 is an example of an aircraft that can have a part manufactured using the illustrative examples.

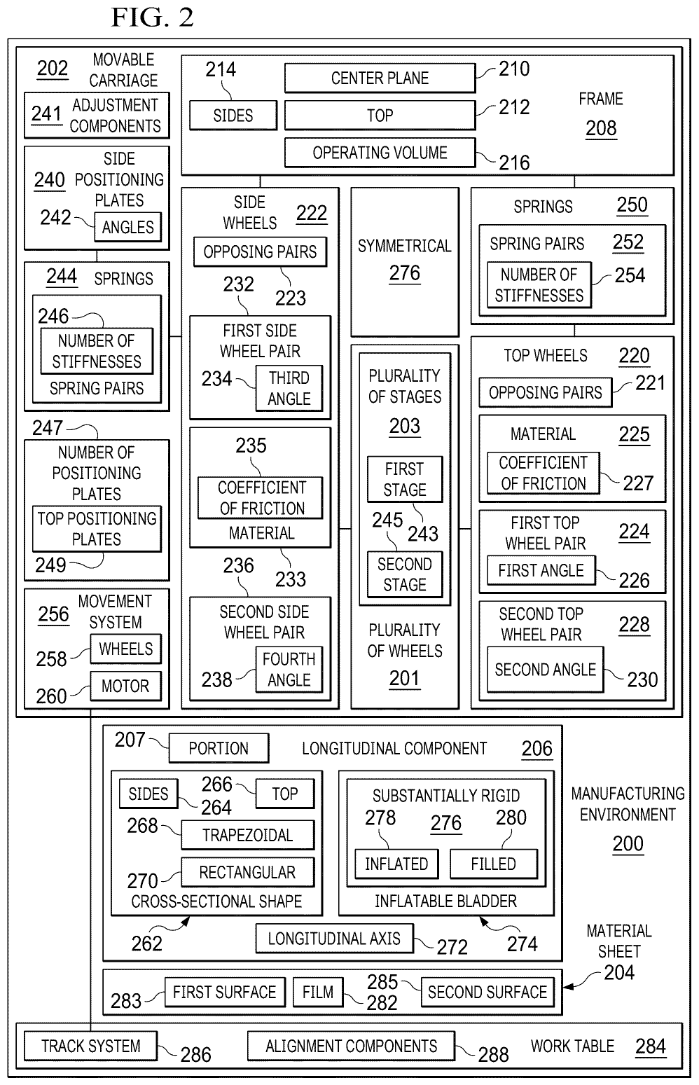

Turning now to FIG. 2, an illustration of a block diagram of a manufacturing environment is depicted in accordance with an illustrative embodiment. In manufacturing environment 200, movable carriage 202 can be used to wrap material sheet 204 around longitudinal component 206. Movable carriage 202 urges material sheet 204 up and around longitudinal component 206 as movable carriage 202 moves along longitudinal component 206. Movable carriage 202 is configured to wrap material sheet 204 around portion 207 of longitudinal component 206 disposed on material sheet 204.

Movable carriage 202 comprises plurality of wheels 201 positioned normal to an outer surface of longitudinal component 206. Movable carriage 202 comprises plurality of wheels 201 positioned normal to a perimeter of cross-sectional shape 262 of longitudinal component 206. In this illustrative example, plurality of wheels 201 is presented as top wheels 220 and side wheels 222. However, the plurality of wheels can be distributed within operating volume 216 in any desirable orientation based on cross-sectional shape 262 of longitudinal component 206 such that the plurality of wheels 201 is normal to a perimeter of cross-sectional shape 262. Angles of plurality of wheels 201 relative to the movement direction of movable carriage 202 drive wrapping of material sheet 204 around longitudinal component 206.

Movable carriage 202 comprises frame 208, plurality of wheels 201 arranged as plurality of stages 203 offset from each other along center plane 210 of frame 208, and number of positioning plates 247 connected to frame 208 and holding plurality of wheels 201 normal to a cross-sectional shape of longitudinal component 206. Each stage of plurality of stages 203 is a subset of plurality of wheels 201 that is positioned on a same plane. Each plane is parallel to cross-sectional shape 262 of longitudinal component 206. Each plane is perpendicular to the center plane 210.

In some illustrative examples, plurality of wheels 201 is arranged in pairs. In some illustrative examples, plurality of wheels 201 can comprise at least one wheel without a counterpart.

Angles of wheels of each respective stage of plurality of stages 203 increase along center plane 210. For example, first stage 243 of plurality of wheels 201 encounter material sheet 204 first and have a number of angles smaller in magnitude than second stage 245 of plurality of wheels 201. The number of angles of wheels in second stage 245 is greater in magnitude to pull material sheet 204 tighter onto longitudinal component 206.

Number of positioning plates 247 comprises one or more positioning plates. In some illustrative examples, a position of each of number of positioning plates 247 is adjustable. Number of positioning plates 247 can be moved to adjust the position of plurality of wheels 201 within operating volume 216. Number of positioning plates 247 can be moved to adjust the normal force provided by plurality of wheels 201 to material sheet 204. Number of positioning plates 247 can be used to hold plurality of wheels 201 normal to an outer surface of longitudinal component 206. Number of positioning plates 247 can be used to hold plurality of wheels 201 normal to a perimeter of cross-sectional shape 262 of longitudinal component 206. Number of positioning plates 247 can be used to provide rigidity to counteract normal forces provided by plurality of wheels 201.

In some illustrative examples, number of positioning plates 247 is comprised of plates placed in parallel to some or all faces of outer surfaces of longitudinal component 206. In some illustrative examples, adjustment of some or all of number of positioning plates 247 maintains symmetric positions of plurality of wheels 201 with respect to longitudinal component 206. In some illustrative examples, adjustment of some or all of number of positioning plates 247 maintains consistent normal force provided by plurality of wheels 201 relative to one another.

Normal position of plurality of wheels 201 relative to cross-sectional shape 262 of longitudinal component 206 can be maintained through wheel mounts attached to frame 208. Normal position of plurality of wheels 201 relative to cross-sectional shape 262 of longitudinal component 206 can be maintained through wheel mounts attached to number of positioning plates 247. Normal position of plurality of wheels 201 relative to cross-sectional shape 262 of longitudinal component 206 can be maintained through clamping forces providing normal force to plurality of wheels 201. Clamping forces providing normal force to plurality of wheels 201 can be provided by mechanical systems, rigid components, forces external to frame 208, or other desirable sources. At least one of frame 208, number of positioning plates 247, or wheel mounts can include one or more mechanical degrees of freedom to maintain compliance with cross-sectional shape 262 of longitudinal component 206. At least one of frame 208, number of positioning plates 247, or wheel mounts can include flexible connections or materials to maintain compliance with cross-sectional shape 262 of longitudinal component 206. At least one of frame 208, number of positioning plates 247, or wheel mounts can include springs, such as springs 244 or springs 250, to maintain compliance with cross-sectional shape 262 of longitudinal component 206.

In some illustrative examples, adjustment components 241 are present between number of positioning plates 247 and frame 208. In some illustrative examples, adjustment components 241 take the form of lead screw assemblies or other types of adjustment components. Adjustment components 241 can be used to adjust the position of plurality of wheels 201 within operating volume 216. Adjustment components 241 can be used to adjust the normal force provided by plurality of wheels 201 to material sheet 204. In some illustrative examples, when present, the lead-screw assemblies provide sufficient locking force to enable number of positioning plates 247 to counteract normal forces from plurality of wheels 201.

Movable carriage 202 is configured to wrap material sheet 204 around longitudinal component 206. Movable carriage 202 is able to create a flat overlapped seam when material sheet 204 is wrapped around longitudinal component 206. Movable carriage 202 comprises frame 208, side wheels 222, and top wheels 220. Frame 208 defines center plane 210 and operating volume 216. Side wheels 222 are within operating volume 216 configured to guide material sheet 204 against sides 264 of portion 207 of longitudinal component 206 when disposed within operating volume 216 and aligned with center plane 210, as movable carriage 202 moves parallel to center plane 210. Side wheels 222 are arranged as one or more opposing pairs 223 about center plane 210. Top wheels 220 are within operating volume 216 and configured to guide material sheet 204 against top 266 of portion 207 of longitudinal component 206 as movable carriage 202 moves parallel to center plane 210. Top wheels 220 are arranged as one or more opposing pairs 221 about center plane 210.

Portion 207 of longitudinal component 206 is located in proximity to movable carriage 202 such that material sheet 204 adjacent to portion 207 is acted upon by movable carriage 202. In some illustrative examples, portion 207 is located within operating volume 216. In some illustrative examples, movement of movable carriage 202 causes lifting of material sheet 204 outside of operating volume 216. In these illustrative examples, portions of material sheet 204 begin lifting off of work table 284 and towards longitudinal component 206 before the portions of material sheet 204 are contacted by side wheels 222 and top wheels 220. In these illustrative examples, portions of material sheet 204 begin lifting off of work table 284 and towards longitudinal component 206 before the portions of material sheet 204 are positioned within frame 208.

In some illustrative examples, prior to wrapping material sheet 204 onto longitudinal component 206, material sheet 204 is placed onto work table 284. In some illustrative examples, material sheet 204 is placed flat onto work table 284 prior to wrapping material sheet 204 around longitudinal component 206. In some illustrative examples, the whole of longitudinal component 206 is placed onto the whole of material sheet 204 prior to wrapping. In some other illustrative examples, material sheet 204 is fed to portion 207 prior to wrapping material sheet 204 around portion 207 of longitudinal component 206.

In some illustrative examples, prior to positioning movable carriage 202, one end of material sheet 204 is initially wrapped around longitudinal component 206. In some illustrative examples, prior to guiding material sheet 204 around longitudinal component 206 using side wheels 222 and top wheels 220 of movable carriage 202, an end of material sheet 204 is wrapped and taped to longitudinal component 206. In some illustrative examples, side wheels 222 and top wheels 220 engage material sheet 204 after an end of material sheet 204 is initially lifted and secured by another method.

As movable carriage 202 moves along longitudinal axis 272 of longitudinal component 206, side wheels 222 and top wheels 220 contact material sheet 204 to grip and guide material sheet 204. Side wheels 222 and top wheels 220 urge material sheet 204 up and around sides 264 and top 266 of cross-sectional shape 262 of longitudinal component 206. Contact of side wheels 222 against material sheet 204 on portion 207 of longitudinal component 206 guides material sheet 204 onto longitudinal component 206. Side wheels 222 and the top wheels 220 are facing into operating volume 216.

Material sheet 204 is lifted by breaking the contact between material sheet 204 and any support surface. In some illustrative examples, side wheels 222 and top wheels 220 are formed of a material having a coefficient of friction with material sheet 204 sufficient to guide material sheet 204 around longitudinal component 206. In some illustrative examples, side wheels 222 are formed of material 233 having coefficient of friction 235 with material sheet 204 sufficient to guide material sheet 204 around longitudinal component 206. In some illustrative examples, top wheels 220 are formed of material 225 having coefficient of friction 227 with material sheet 204 sufficient to guide material sheet 204 around longitudinal component 206.

Different levels of force can be applied by at least one of side wheels 222 or top wheels 220 to material sheet 204 depending upon the type of material of material sheet 204. For a lower friction material, less force can be applied. If the friction between a respective wheel material and material sheet 204 is much larger than the friction between material sheet 204 and the exposed surface of longitudinal component 206, less force can be applied. If the difference in coefficients of friction between material sheet 204 and the wrap surface of longitudinal component 206 and material sheet 204 and a respective wheel material is small, normal force can be increased to amplify the wrapping power of the wheels.

In some illustrative examples, at least one of top wheels 220 or side wheels 222 are spring-loaded and clamping force can be applied by springs. For a higher friction material, greater clamping force can be applied by providing one or more springs. In some illustrative examples, the spring is positioned between a respective wheel of plurality of wheels 201 and a respective positioning plate of number of positioning plates 247. For a higher friction material, greater clamping force can be applied by increasing the loading of a respective spring or springs. More friction by the wheels can be applied by increasing the normal force or by modifying the material of the wheels itself.

Friction forces can be created or increased due to rotation of plurality of wheels 201. Friction forces can be created or increased due to dragging of plurality of wheels 201 in direction of movement of movable carriage 202. Friction forces can be created or increased due to movement of material sheet 204. In some illustrative examples, movement of movable carriage 202 provides friction forces through passive movement of at least one wheel of plurality of wheels 201. In some illustrative examples, movement of movable carriage 202 provides friction forces through actively driven rotation of at least one wheel of plurality of wheels 201. In some illustrative examples, movement of the movable carriage provides friction forces through dragging of at least one wheel of plurality of wheels 201.

Material sheet 204 has two surfaces, first surface 283 and second surface 285. Prior to wrapping material sheet 204 around longitudinal component 206, first surface 283 faces longitudinal component 206. When material sheet 204 is wrapped around longitudinal component 206, at least a portion of first surface 283 is in contact with longitudinal component 206. Prior to wrapping material sheet 204 around longitudinal component 206, second surface 285 faces away from longitudinal component 206. In some illustrative examples, first surface 283 can be referred to as an inner surface. In some illustrative examples, second surface 285 can be referred to as an outer surface.

Top wheels 220 or side wheels 222 contact second surface 285 while guiding material sheet 204. In some illustrative examples, first surface 283 and second surface 285 have different textures from each other. In some illustrative examples, a difference in textures can influence how strongly top wheels 220 or side wheels 222 urge material sheet 204 against longitudinal component 206. In some illustrative examples, first surface 283 can have an attractive or adhesive effect. In some illustrative examples, if first surface 283 is at least partially attracted to or adhered to longitudinal component 206, top wheels 220 or side wheels 222 may use less force to urge material sheet 204.

In some illustrative examples, at least one of top wheels 220 or side wheels 222 are spring loaded. In some illustrative examples, movable carriage 202 comprises springs arranged in spring pairs, wherein each spring pair of spring pairs is connected to a respective wheel of one of top wheels 220 or side wheels 222. In some illustrative examples, movable carriage 202 comprises springs 244 arranged in spring pairs 246, wherein each spring pair of spring pairs 246 is connected to a respective wheel of side wheels 222. In some illustrative examples, movable carriage 202 comprises springs 250 arranged in spring pairs 252, wherein each spring pair of spring pairs 252 is connected to a respective wheel of top wheels 220. When present, springs 244 and springs 250 provide compliance for movable carriage 202.

Spring pairs 246 have number of stiffnesses 248. In some illustrative examples, at least one spring pair of spring pairs 246 has the same stiffness in both springs in the spring pair. In some illustrative examples, each spring pair has two different stiffnesses in the pair. In some illustrative examples, number of stiffnesses 248 is selected to provide urging of material sheet 204. Number of stiffnesses 248 is selected to modify intensity of urging of material sheet 204.

Springs 250 can be used to apply pressure to material sheet 204. In some illustrative examples, pressure applied by springs 250 aids in gripping and lifting material sheet 204. Any desirable quantity of springs 250 can be attached to each of side wheels 222. In some illustrative examples, springs 250 are arranged in spring pairs 252. In some illustrative examples, side wheels 222 are connected to sides 214 of frame 208 by spring pairs 252.

Spring pairs 252 have number of stiffnesses 254. In some illustrative examples, at least one spring pair of spring pairs 252 has the same stiffness in both springs in the spring pair. In some illustrative examples, each spring pair has two different stiffnesses. In some illustrative examples, number of stiffnesses 254 is selected to provide urging of material sheet 204.

In some illustrative examples, at least one spring pair of spring pairs 246 or spring pairs 252 has a stiffer spring towards the front of movable carriage 202. In these illustrative examples, the spring in at least one spring pair of at least one of spring pairs 246 or spring pairs 252 is stiffer in the direction of movement.

A difference in force putting the normal force at an angle aids in moving material sheet 204 into place. When number of stiffnesses 254 has more than one stiffness, the spring pair can put the normal force at an angle. In some illustrative examples, a design of movable carriage 202 allows for an external force to apply the normal force at an angle. In some illustrative examples, frame 208 is flexible or jointed in select locations to allow a force external to frame 208 to be imparted on movable carriage 202. Imparting a force external to frame 208 can apply the normal force at an angle.

In some illustrative examples, movable carriage 202 comprises side positioning plates 240 connecting side wheels 222 to sides 214 of frame 208 at angle 242 configured to engage sides 264 of longitudinal component 206. In these illustrative examples, side positioning plates 240 are positioning plates of number of positioning plates 247. In some illustrative examples, side positioning plates 240 are present for side wheels 222 to engage sides 264 of trapezoidal 268 cross-sectional shape 262 of longitudinal component 206. Side positioning plates 240 are adjustable. Side positioning plates 240 enable an adjustable normal force which correlates with an adjustable net wrapping force to wrap material sheet 204 based on coefficient of friction 235.

In some illustrative examples, movable carriage 202 comprises top positioning plates 249 connecting top wheels 220 to frame 208. In these illustrative examples, top positioning plates 249 are ones of number of positioning plates 247 connected to top wheels 220. In these illustrative examples, top positioning plates 249 place top wheels 220 normal to cross-sectional shape 262 of longitudinal component 206.

Side wheels 222 are arranged in a series of stages. First stage 243 of side wheels 222 encounters a portion of material sheet 204 first. First stage 243 of side wheels 222 provides lift to material sheet 204. Subsequent stages of wheels of side wheels 222 more aggressively pull material sheet 204 tighter around longitudinal component 206. For example, second stage 245 of side wheels 222 encounters a portion of material sheet 204 after first stage 243. A number of respective angles of side wheels 222 in first stage 243 are smaller in magnitude than a number of respective angles of side wheels 222 in second stage 245. Magnitudes of respective angles of side wheels 222 can be increased per stage in the progressive stages.

In some illustrative examples, each stage of side wheels 222 can comprise a respective pair of side wheels. In some illustrative examples, each respective pair of side wheels 222 has a same angle relative to longitudinal component 206 to cause movable carriage 202 to be symmetrical 218. In other illustrative examples, wheels of a respective pair of side wheels 222 can have different angles relative to longitudinal component 206.

In some illustrative examples, each pair of side wheels 222 has a respective position along center plane 210 such that movable carriage is symmetrical 218. In some illustrative examples, wheels of a respective pair of side wheels 222 can be offset from each other along center plane 210.

In some illustrative examples, side wheels 222 comprise first side wheel pair 232 positioned at third angle 234. In some illustrative examples, side wheels 222 comprise second side wheel pair 236 positioned at fourth angle 238. In some illustrative examples, fourth angle 238 is greater than third angle 234.

Third angle 234 and fourth angle 238 can be measured relative to a manufacturing floor. Third angle 234 and fourth angle 238 can be measured relative to a longitudinal direction of longitudinal component 206.

In some illustrative examples, top wheels 220 comprise first top wheel pair 224 positioned at first angle 226 relative to center plane 210. In some illustrative examples, top wheels 220 comprise second top wheel pair 228 positioned at second angle 230 relative to center plane 210. In some illustrative examples, second angle 230 is greater than first angle 226.

In some illustrative examples, first angle 226 is approximately 15 degrees and second angle 230 is approximately 30 degrees. In some illustrative examples, side wheels 222 are connected to sides 214 of frame 208 and top wheels 220 are connected to top 212 of frame 208.

In some illustrative examples, first angle 226 and second angle 230 can be selected from a range of 0 degrees to 30 degrees. In some illustrative examples, first angle 226 and second angle 230 can be selected from a range of 0 degrees to 45 degrees. In some illustrative examples, first angle 226 and second angle 230 can be selected from a range of 0 degrees to 60 degrees. In some illustrative examples, first angle 226 and second angle 230 can be selected from a range of 15 degrees to 30 degrees.

In some illustrative examples, third angle 234 and fourth angle 238 can be selected from a range of 0 degrees to 30 degrees. In some illustrative examples, third angle 234 and fourth angle 238 can be selected from a range of 0 degrees to 45 degrees. In some illustrative examples, third angle 234 and fourth angle 238 can be selected from a range of 0 degrees to 60 degrees. In some illustrative examples, third angle 234 and fourth angle 238 can be selected from a range of 15 degrees to 30 degrees. Third angle 234 is selected to provide a first initial lift of material sheet 204. Increasing third angle 234 can more aggressively pull material from a flat orientation to curve around longitudinal component 206. In some illustrative examples, having an overly large third angle 234 can cause inconsistencies such as wrinkles. Fourth angle 238 is greater than third angle 234 to pull material sheet 204 tighter towards the back of movable carriage 202.

In some illustrative example, movable carriage 202 comprises movement system 256. Movement system 256 is connected to frame 208 and configured to move movable carriage 202 in a direction parallel to center plane 210. In some illustrative examples, movement system 256 is at least partially powered. In some illustrative examples, movement system 256 comprises motor 260 configured to at least partially drive movable carriage 202 parallel to center plane 210. In some illustrative examples, movement system 256 is manually operated.

In some illustrative examples, movement system 256 comprises wheels 258 configured to travel on a track system 286. In some illustrative examples, movement system 256 comprises linear sliders configured to travel on a track system 286. A position of movable carriage 202 relative to a center of longitudinal component 206 can be controlled using movement system 256. Movement system 256 can be used to keep components of movable carriage 202 symmetric about longitudinal component 206. In some illustrative examples, movable carriage 202 is hand-held. In some illustrative examples, movement system 256 is configured to control position of movable carriage 202 relative to longitudinal component 206.

In some illustrative examples, movable carriage 202 comprises frame 208 with center plane 210, top 212, and sides 214, movement system 256 connected to sides 214 of frame 208, side wheels 222 connected to frame 208, and top wheels 220 connected to frame 208. Movement system 256 is configured to move movable carriage 202 in a movement direction parallel to center plane 210. Side wheels 222 comprise a first side wheel pair 232 symmetric about center plane 210, and second side wheel pair 236 symmetric about center plane 210 and offset from first side wheel pair 232 along center plane 210.

In some illustrative examples, top wheels 220 are arranged in a series of stages. In some illustrative examples, first stage 243 of top wheels 220 encounters a portion of material sheet 204 first. First stage 243 of top wheels 220 provides lift to material sheet 204. Subsequent stages of wheels of top wheels 220 more aggressively pull material sheet 204 tighter around longitudinal component 206. For example, second stage 245 of top wheels 220 encounters a portion of material sheet 204 after first stage 243. A number of respective angles of top wheels 220 in first stage 243 are smaller in magnitude than a number of respective angles of top wheels 220 in second stage 245. Magnitudes of respective angles of top wheels 220 can be increased per stage in the progressive stages.

In some illustrative examples, each stage of top wheels 220 can comprise a respective pair of top wheels. In some illustrative examples, each respective pair of top wheels 220 has a same angle relative to longitudinal component 206 to cause movable carriage 202 to be symmetrical 218. In other illustrative examples, wheels of a respective pair of top wheels 220 can have different angles relative to longitudinal component 206.

In some illustrative examples, each pair of top wheels 220 has a respective position along center plane 210 such that movable carriage is symmetrical 218. In some illustrative examples, wheels of a respective pair of top wheels 220 can be offset from each other along center plane 210.

Top wheels 220 comprise first top wheel pair 224 symmetric about center plane 210 and angled away from each other at first angle 226 and second top wheel pair 228 symmetric about the center plane 210 and angled away from each other at second angle 230.

In some illustrative examples, second angle 230 of second top wheel pair 228 is greater than first angle 226 of first top wheel pair 224. In some illustrative examples, second angle 230 of second top wheel pair 228 is approximately 30 degrees and first angle 226 of first top wheel pair 224 is approximately 15 degrees.

Longitudinal component 206 takes the form of any desirable component that has a substantially greater length than other measurements. In some illustrative examples, longitudinal component 206 is a part or product that is being manufactured. In some illustrative examples, longitudinal component 206 is a tool or other manufacturing apparatus for the manufacture of a part or product. In some illustrative examples, longitudinal component 206 takes the form of inflatable bladder 274.

Longitudinal component 206 has cross-sectional shape 262. Cross-sectional shape 262 is a shape perpendicular to longitudinal axis 272. Cross-sectional shape 262 has any desirable shape. In some illustrative examples, cross-sectional shape 262 is trapezoidal 268. In some illustrative examples, cross-sectional shape 262 is trapezoidal 268 with convex or bulbous edges.

Longitudinal component 206 takes any desirable shape and is not limited to quadrilaterals.

To wrap material sheet 204 around longitudinal component 206, longitudinal component 206 is substantially rigid 276. When longitudinal component 206 is substantially rigid 276, longitudinal component 206 can provide reaction forces sufficient to counteract normal forces from plurality of wheels 201. In some illustrative examples, longitudinal component 206 is substantially rigid 276 for wrapping without additional processing or steps. In some illustrative examples, longitudinal component 206 is hollow or flexible and additional steps are taken to make portion 207 substantially rigid 276 to wrap material sheet 204 around portion 207 of longitudinal component 206.

In some illustrative examples, when longitudinal component 206 takes the form of inflatable bladder 274, inflatable bladder 274 is one of inflated 278 or filled 280 to make inflatable bladder 274 substantially rigid 276. Inflatable bladder 274 can be filled 280 with any desirable type of solid or fluid material. In some illustrative examples, inflatable bladder 274 can be filled 280 with a loose material or a solid shape.

Material sheet 204 takes the form of any desirable material for one of manufacturing or providing desired surface characteristics for a product. In some illustrative examples, material sheet 204 is a material wrapped around tooling or other manufacturing components. In some illustrative examples, material sheet 204 is wrapped around a product to provide a desired property or functionality. In some illustrative examples, material sheet 204 comprises one of a release film, a breather, or any other desirable type of film.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, although only one material sheet, material sheet 204 is depicted, any desirable quantity of material sheets can be wrapped around longitudinal component 206 using movable carriage 202. In some illustrative examples, multiple material sheets are wrapped in multiple passes of movable carriage 202 along longitudinal axis 272 of longitudinal component 206.

In some illustrative examples, although only one movable carriage, movable carriage 202 is depicted, multiple carriages can be linked together to provide wrapping of multiple material sheets in one pass. In some illustrative examples, multiple movable carriages with a same design can be used to wrap multiple material sheets substantially simultaneously.

As another example, although only two stages, first stage 243 and second stage 245 of side wheels 222 are depicted, any desirable quantity of stages can be provided for side wheels 222. In some illustrative examples, more than two stages of wheels are provided for side wheels 222.

Additionally, although side wheels 222 and top wheels 220 are depicted as each having two stages, in some illustrative examples, side wheels 222 and top wheels 220 have different quantities of stages. In some illustrative examples, side wheels 222 have more stages than top wheels 220. In some illustrative examples, top wheels 220 have more stages than side wheels 222.

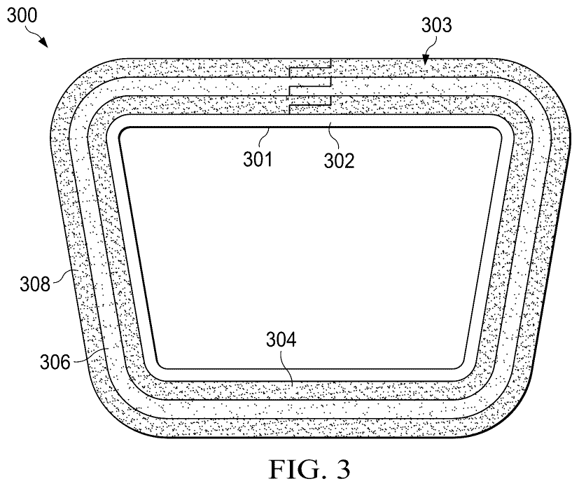

Turning now to FIG. 3, an illustration of a cross-sectional view of a longitudinal component with plurality of material sheets 303 is depicted in accordance with an illustrative embodiment. In view 300 a plurality of material sheets have been wrapped around longitudinal component 301. In this illustrative example, longitudinal component 301 takes the form of inflatable bladder 302. Inflatable bladder 302 is hollow. To apply plurality of material sheets 303 to inflatable bladder 302, inflatable bladder 302 is placed into a substantially rigid state. Inflatable bladder 302 can be placed into a substantially rigid state using any desirable method. In some illustrative examples, inflatable bladder 302 can be placed into a substantially rigid state by pressuring inflatable bladder 302 or by inserting a sufficiently rigid material into inflatable bladder 302.

Plurality of material sheets 303 can comprise any desirable type of material sheets. In some illustrative examples, plurality of material sheets 303 comprises at least one of a release film, a breather, or any other desirable type of film. In some illustrative examples, each of plurality of material sheets 303 is wrapped around longitudinal component 301 sequentially. In some illustrative examples, each of plurality of material sheets 303 is wrapped sequentially by a single movable carriage. In this example, material sheet 304 is wrapped around longitudinal component 301 by the movable carriage, and then movable carriage is reset and used to wrap material sheet 306 followed by material sheet 308.

In some illustrative examples, plurality of material sheets 303 can be wrapped around longitudinal component 301 concurrently. In some illustrative examples, plurality of material sheets 303 are wrapped around longitudinal component 301 by a series of movable carriages moving along longitudinal component 301 at the same time. In these illustrative examples, plurality of material sheets 303 are wrapped around longitudinal component 301 substantially simultaneously with a second wrap starting before the first wrap is finished.

Each of material sheet 304, material sheet 306, and material sheet 308 is schematically shown in FIG. 3 to have an overlap. Each overlap is a small portion of the respective material sheet that is on top of and in contact with itself. In other illustrative examples, at least one of material sheet 304, material sheet 306, and material sheet 308 can have abutting edges with itself, such as to create a seam. In these illustrative examples, at least one of material sheet 304, material sheet 306, and material sheet 308 may not have an overlap. In FIG. 3, the overlap is illustrated as occurring in the same position relative to the longitudinal component for each of the plurality of material sheets 303 wrapped around longitudinal component 301. However, this is not required to all embodiments, as the position of overlaps or seams for the material layers may vary with respect to each other, such as depending on the initial alignment or position of each material sheet with the longitudinal component.

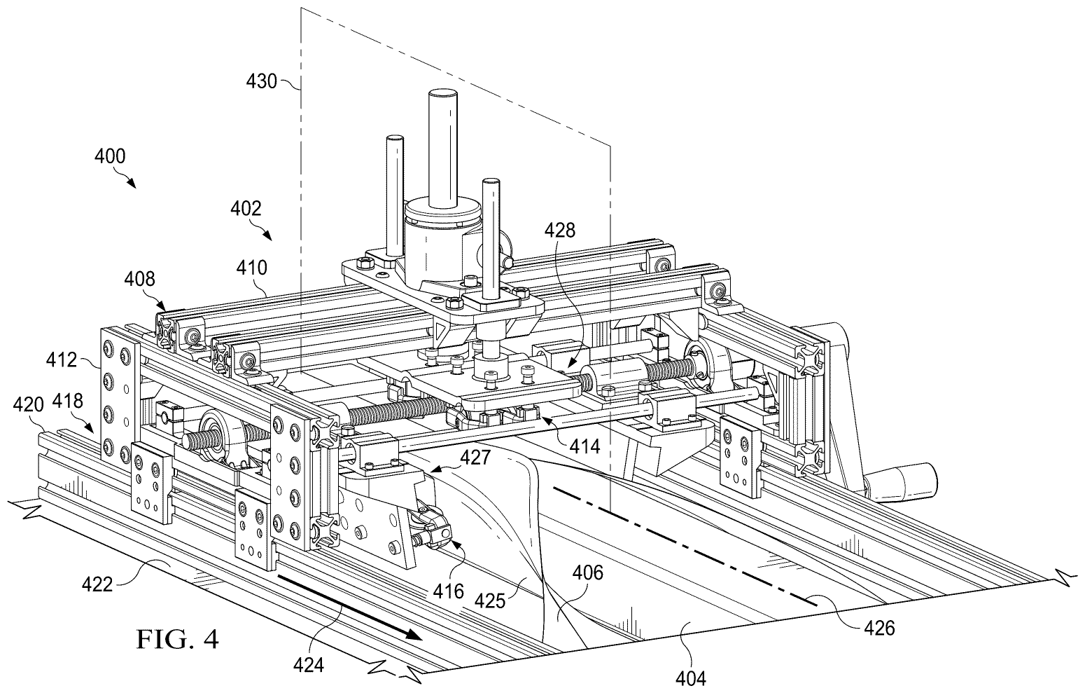

Turning now to FIG. 4, an illustration of an isometric view of a movable carriage applying a material sheet around a longitudinal component is depicted in accordance with an illustrative embodiment. In view 400, movable carriage 402 is moving along longitudinal component 404 to wrap material sheet 406 around longitudinal component 404. Movable carriage 402 is a physical implementation of movable carriage 202 of FIG. 2. Movable carriage 402 can be used to wrap at least one material sheet of plurality of material sheets 303 of FIG. 3.

Movable carriage 402 is configured to wrap material sheet 406 around longitudinal component 404 placed on material sheet 406. Movable carriage 402 comprises frame 408 defining center plane 430 and operating volume 428, side wheels 416 within operating volume 428, and top wheels 414 within operating volume 428. In this illustrative example, side wheels 416 are connected to sides 412 of frame 408 and top wheels 414 are connected to top 410 of frame 408.

Side wheels 416 are configured to guide material sheet 406 against sides 425 of portion 427 of longitudinal component 404, when disposed within operating volume 428 and aligned with center plane 430, as movable carriage 402 moves parallel to center plane 430. As depicted, longitudinal axis 426 of longitudinal component 404 is aligned with center plane 430 defined by movable carriage 402. Side wheels 416 are arranged as one or more opposing pairs about center plane 430. In this illustrative example, side wheels 416 are spring loaded.

Portion 427 of longitudinal component 404 is located in proximity to movable carriage 402 such that material sheet 406 adjacent to portion 427 is acted upon by movable carriage 402. In some illustrative examples, portion 427 is located within operating volume 428. In some illustrative examples, movement of movable carriage 402 causes lifting of material sheet 406 outside of operating volume 428.

Top wheels 414 within operating volume 428 are configured to guide the material sheet 406 against the top of portion 427 of longitudinal component 404 as movable carriage 402 moves parallel to center plane 430. In some illustrative examples, top wheels 414 are arranged as one or more opposing pairs about center plane 430. Side wheels 416 and top wheels 414 are facing into operating volume 428.

In this illustrative example, movable carriage 402 comprises movement system 418 connected to frame 408 and configured to move movable carriage 402 in direction 424 parallel to center plane 430. In some illustrative examples, movement system 418 comprises wheels configured to travel on track system 420. In some illustrative examples, movement system 418 comprises a bearing system configured to interact with track system 420.

Movable carriage 402 is configured to wrap material sheet 406 around longitudinal component 404. In this illustrative example, movable carriage 402 comprises frame 408 with center plane 430, top 410, and sides 412; movement system connected to sides 412 of the frame, side wheels 416 connected to frame 408, and top wheels 414 connected to frame 408. Movable carriage 402 further comprises movement system 418 configured to move movable carriage 402 in direction 424 parallel to center plane 430.

In view 400, material sheet 406 is being wrapped around longitudinal component 404. Movable carriage 402 has been positioned such that longitudinal component 404 is within operating volume 428 beneath frame 408 of movable carriage 402.

Movable carriage 402 is being moved in direction 424 parallel to longitudinal axis 426 of longitudinal component 404. Material sheet 406 is guided around longitudinal component 404 using wheels of movable carriage 402 within operating volume 428 as movable carriage 402 moves in direction 424. In this illustrative example, moving movable carriage 402 comprises moving movable carriage 402 along track system 420 of work table 422 supporting longitudinal component 404.

In view 400, movable carriage 402 is guiding material sheet 406 around longitudinal component 404 using top wheels 414 and side wheels 416. Movable carriage 402 is guiding material sheet 406 onto sides 425 of portion 427 of longitudinal component 404 using side wheels 416 connected to sides 412 of frame 408 and arranged as opposing pairs about center plane 430 defined by frame 408.

Side wheels 416 and top wheels 414 are passively driven by moving movable carriage 402 in direction 424. Wrapping material sheet 406 around longitudinal component 404 is performed by movement of side wheels 416 and top wheels 414. Wrapping material sheet 406 is performed due to the angles of side wheels 416 and top wheels 414 relative to direction 424 of movement. In this illustrative example, guiding material sheet 406 around longitudinal component 404 comprises passively driving the wheels by moving movable carriage 402 in direction 424.

In some illustrative examples, movement system 418 comprises a motor configured to at least partially drive movable carriage 402 parallel to center plane 430. In some illustrative examples, moving movable carriage 402 comprises at least partially powering movement of movable carriage 402 using a motor.

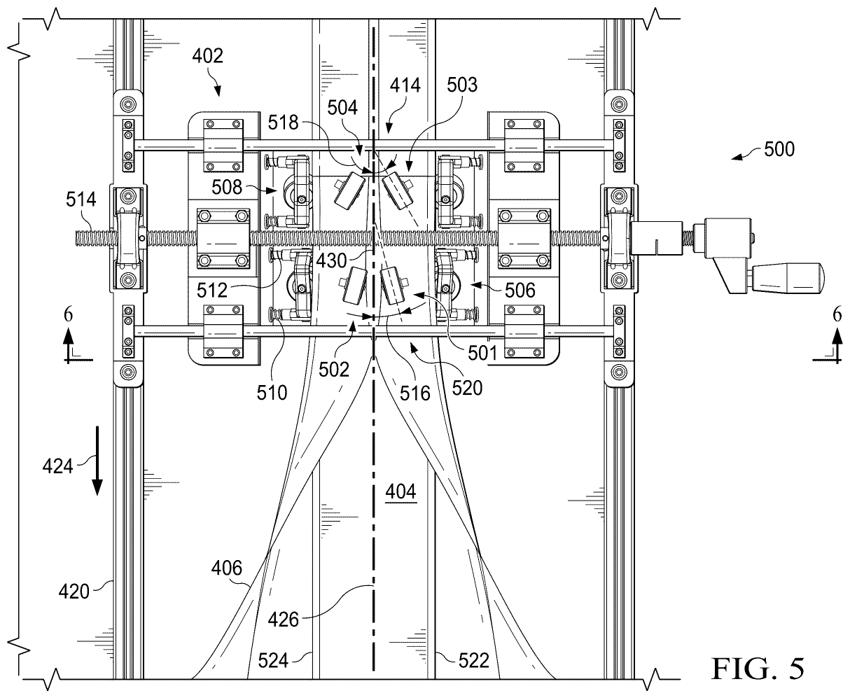

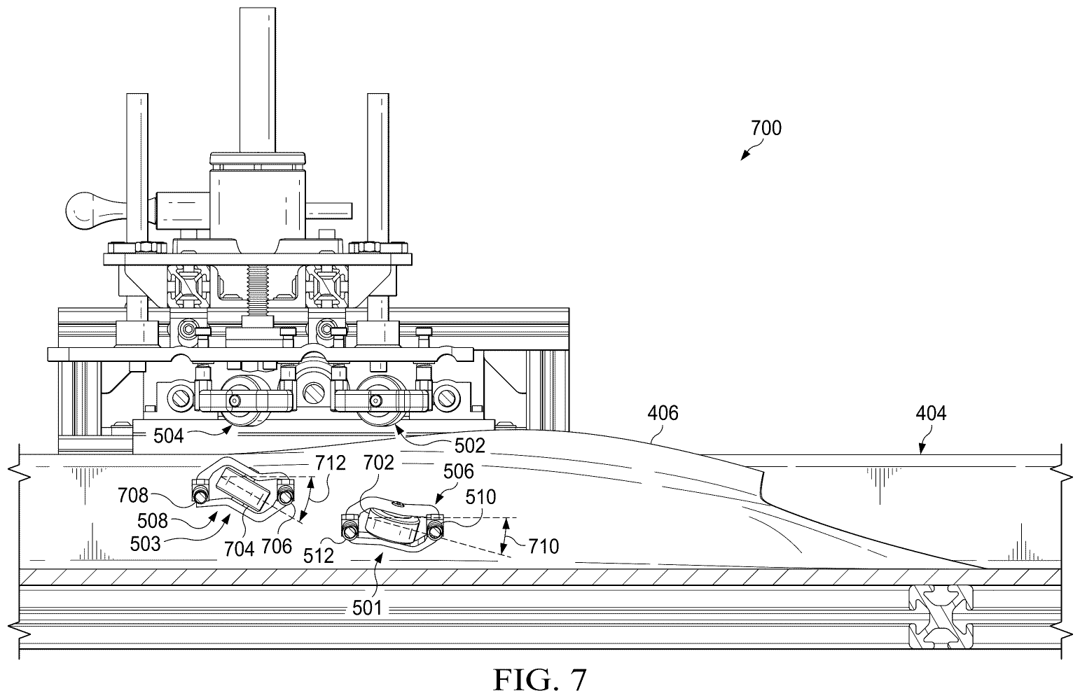

Turning now to FIG. 5, an illustration of a top view of a movable carriage applying a material sheet around a longitudinal component is depicted in accordance with an illustrative embodiment. In view 500, top wheels 414 are visible. FIGS. 5 and 7 demonstrate position of the wheels of movable carriage 402 relative to surface planes of longitudinal component 404.

Top wheels 414 are arranged in a series of stages. Each stage of the series of stages progressively increases an angle of the respective wheels. Increasing the angle of each respective stage progressively moves material sheet 406 towards longitudinal component 404. In this illustrative example, top wheels 414 are arranged in two stages: first stage 501 comprising first top wheel pair 502 and second stage 503 comprising second top wheel pair 504. As depicted, the angle of the wheels in second stage 503 of top wheels 414 is greater than the angle of the wheels in first stage 501 of top wheels 414. Although first stage 501 is symmetric and second stage 503 is symmetric, in some illustrative examples, at least one of first stage 501 or second stage 503 can be asymmetric.

First stage 501 further comprises first side wheel pair 506. First top wheel pair 502 and first side wheel pair 506 are positioned at a same location along center plane 430. Second stage 503 further comprises second side wheel pair 508. Second top wheel pair 504 and second side wheel pair 508 are positioned at a same location along center plane 430.

Top wheels 414 comprise first top wheel pair 502 symmetric about center plane 430 and angled away from each other at first angle 516, and second top wheel pair 504 symmetric about center plane 430 and angled away from each other at second angle 518. In this illustrative example, top wheels 414 comprise first top wheel pair 502 positioned at first angle 516 relative to center plane 430. In this illustrative example, top wheels 414 comprise second top wheel pair 504 positioned at second angle 518 relative to center plane 430. In this illustrative example, second angle 518 is greater than first angle 516. As depicted, first angle 516 is approximately 15 degrees and second angle 518 is approximately 30 degrees.

Side wheels 416 comprise first side wheel pair 506 symmetric about center plane 430 and second side wheel pair 508 symmetric about center plane 430 and offset from first side wheel pair 506 along center plane 430. First side wheel pair 506 is located forward of second side wheel pair 508 in direction 424. First top wheel pair 502 is located forward of second top wheel pair 504 in direction 424.

In this illustrative example, guiding material sheet 406 around longitudinal component 404 using wheels of movable carriage 402 within the operating volume 428 as movable carriage 402 moves in direction 424 comprises sequentially contacting material sheet 406 with opposing pairs of wheels at increasing angles relative to direction 424. In this illustrative example, guiding material sheet 406 onto top 520 of longitudinal component 404 uses top wheels 414 connected to top 410 of the frame 408 and arranged as opposing pairs about center plane 430.

In this illustrative example, side wheels 416 are spring loaded. In this illustrative example, side wheels 416 are connected to sides 412 of frame 408 by spring pairs. In this illustrative example, the springs are arranged in spring pairs, wherein each spring pair of the spring pairs is connected to a respective wheel of one of top wheels 414 or side wheels 416. In some illustrative examples, each spring pair has two different stiffnesses. An example of a spring pair is spring 510 and spring 512. In some illustrative examples, spring 510 and spring 512 have two different stiffnesses. The force provided by the springs applies a normal force to side 522 and side 524 of longitudinal component 404.

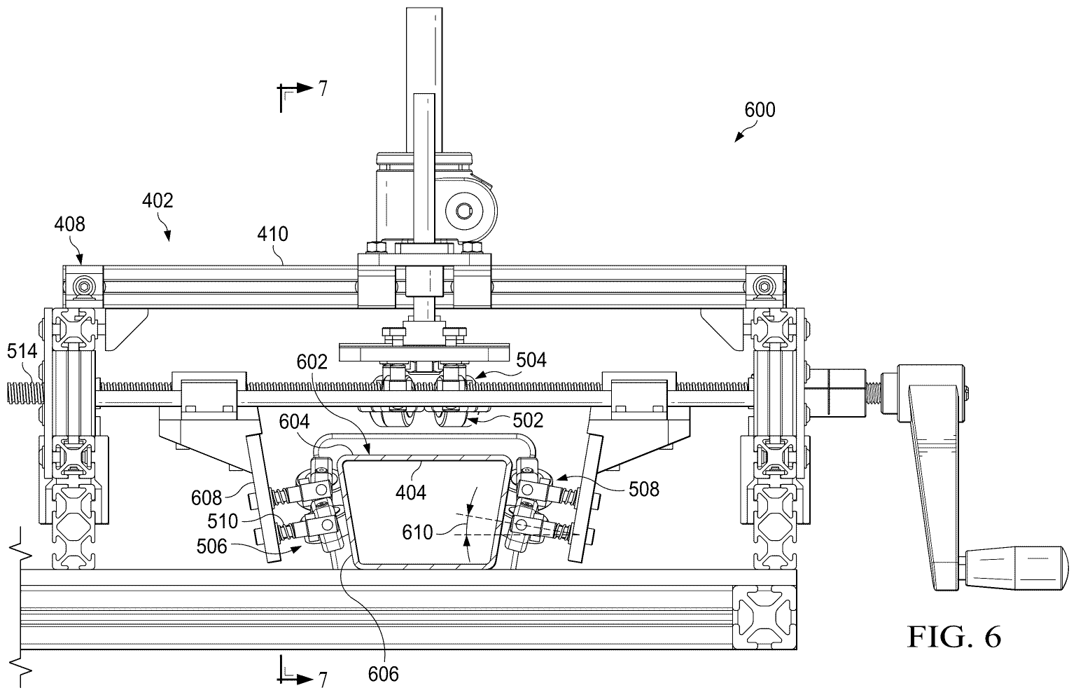

Turning now to FIG. 6, an illustration of a front cross-sectional view of a movable carriage applying a material sheet around a longitudinal component is depicted in accordance with an illustrative embodiment. FIG. 6 demonstrates position of the wheels of movable carriage 402 relative to a cross-section of longitudinal component 404. Longitudinal component 404 has cross-sectional shape 602 with top 604 and sides 606. In this illustrative example, cross-sectional shape 602 is trapezoidal. In this illustrative example, movable carriage 402 comprises side positioning plates 608. Side positioning plates 608 connect side wheels 416 to sides of frame at angle 610 configured to engage sides 606 of longitudinal component 404. Angle 610 is the same in the longitudinal direction of longitudinal component 404.

Turning now to FIG. 7, an illustration of a side view of a movable carriage applying a material sheet around a longitudinal component is depicted in accordance with an illustrative embodiment. In view 700, side wheels 416 are visible.

Side wheels 416 are arranged in a series of stages. Each stage of the series of stages progressively increases an angle of the respective wheels. Increasing the angle of each respective stage progressively moves material sheet 406 towards longitudinal component 404. In this illustrative example, side wheels 416 comprises two stages: first stage 501 comprising first side wheel pair 506 and second stage 503 comprising second side wheel pair 508. As depicted, the angle of the wheels in second stage 503 of top wheels 414 is greater than the angle of the wheels in first stage 501 of top wheels 414. Although first stage 501 is symmetric and second stage 503 is symmetric, in some illustrative examples, at least one of first stage 501 or second stage 503 can be asymmetric.

In view 700 side wheel 702 of first side wheel pair 506 and side wheel 704 of second side wheel pair 508 are visible. Spring 510 and spring 512 are connected to side wheel 702. Spring 706 and spring 708 are connected to side wheel 704. In some illustrative examples, the stiffnesses of spring 510 and spring 512 are the same. In some illustrative examples, the stiffness of spring 510 is greater than the stiffness of spring 512.

In some illustrative examples, the stiffnesses of spring 706 and spring 708 are the same. In some illustrative examples, the stiffness of spring 706 is greater than the stiffness of spring 708. In some illustrative examples, the front springs, spring 510 and spring 706 have the same stiffness greater than the stiffness of spring 512 and spring 708.

First side wheel pair 506 is positioned at third angle 710. Second side wheel pair 508 is positioned at fourth angle 712. Fourth angle 712 is greater than third angle 710. As depicted, third angle 710 is approximately 15 degrees. As depicted, fourth angle 712 is approximately 30 degrees. Third angle 710 and fourth angle 712 are angles in the longitudinal direction of longitudinal component 404.

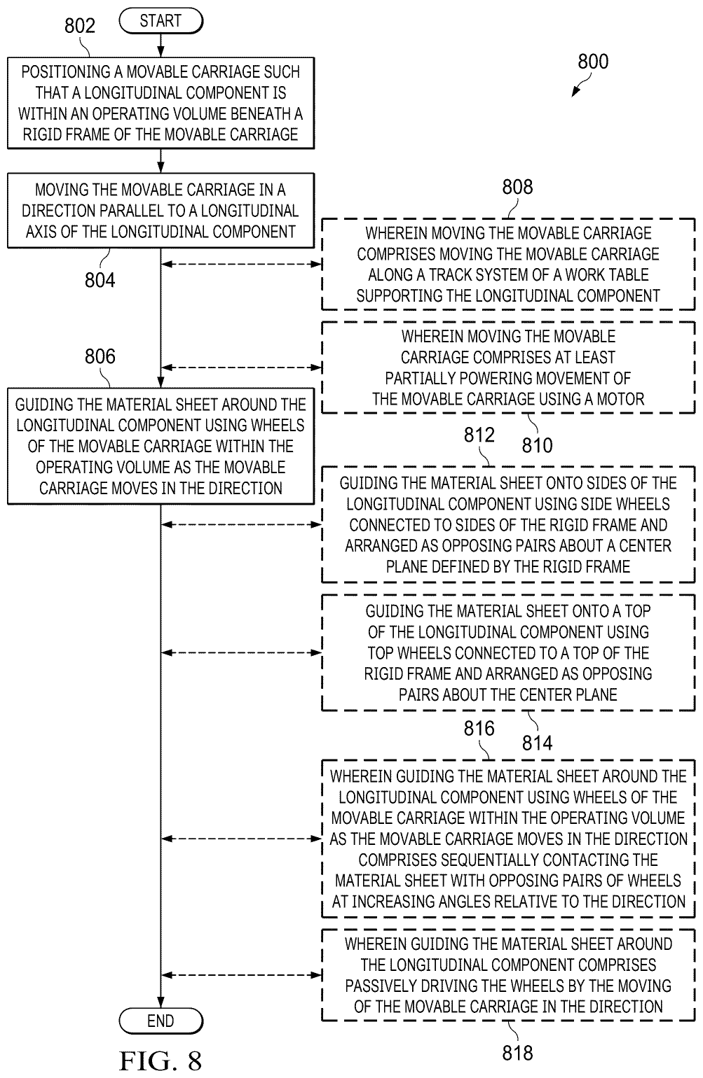

Turning now to FIG. 8, a flowchart of a method of wrapping a material sheet around a longitudinal component is depicted in accordance with an illustrative embodiment. Method 800 can be implemented in manufacturing a component of aircraft 100 of FIG. 1. Method 800 can be performed using movable carriage 202 of FIG. 2. Method 800 can be performed to wrap at least one material sheet of plurality of material sheets 303 on longitudinal component 301 of FIG. 3. Method 800 can be performed using movable carriage 402 of FIGS. 4-7.

Method 800 positions a movable carriage such that a longitudinal component is within an operating volume beneath a frame of the movable carriage (operation 802). Method 800 moves the movable carriage in a direction parallel to a longitudinal axis of the longitudinal component (operation 804). Method 800 guides the material sheet around the longitudinal component using wheels of the movable carriage within the operating volume as the movable carriage moves in the direction (operation 806). Afterwards, method 800 terminates.

In some illustrative examples, moving the movable carriage comprises moving the movable carriage along a track system of a work table supporting the longitudinal component (operation 808). In some illustrative examples, the track system can align movement of the movable carriage with a longitudinal axis of the longitudinal component. In some illustrative examples, moving the movable carriage comprises at least partially powering movement of the movable carriage using a motor (operation 810). In some illustrative examples, a motor fully powers the movement of the movable carriage. In some illustrative examples, a motor reduces the force provided by an operator to move the movable carriage.

In some illustrative examples, guiding the material sheet around the longitudinal component using the wheels comprises guiding the material sheet onto sides of the longitudinal component using side wheels connected to sides of the frame and arranged as one or more opposing pairs about a center plane defined by the frame (operation 812). In some illustrative examples, guiding the material sheet around the longitudinal component using the wheels comprises guiding the material sheet onto a top of the longitudinal component using top wheels connected to a top of the frame and arranged as one or more opposing pairs about the center plane (operation 814).

In some illustrative examples, guiding the material sheet around the longitudinal component using wheels of the movable carriage within the operating volume as the movable carriage moves in the direction comprises sequentially contacting the material sheet with one or more opposing pairs of wheels at increasing angles relative to the direction (operation 816). In some illustrative examples, guiding the material sheet around the longitudinal component comprises passively driving the wheels by the moving of the movable carriage in the direction (operation 818).

In some illustrative examples, prior to positioning the movable carriage, one end of the material sheet is initially wrapped around the longitudinal component. In some illustrative examples, prior to guiding the material sheet around the longitudinal component using the wheels of the movable carriage, an end of the material sheet is wrapped and taped to the longitudinal component. In some illustrative examples, the wheels engage the material sheet after an end of the material sheet is initially lifted by another method.

As used herein, the phrase “at least one of,” when used with a list of items, means different combinations of one or more of the listed items may be used and only one of each item in the list may be needed. For example, “at least one of item A, item B, or item C,” may include, without limitation, item A, item A and item B, or item B. This example also may include item A, item B, and item C, or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 808 through operation 818 may be optional.

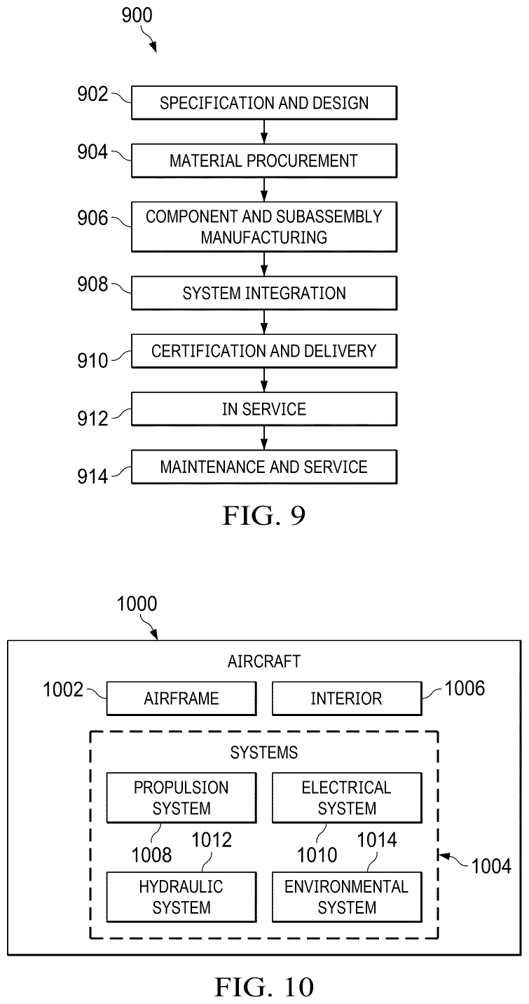

Illustrative embodiments of the present disclosure may be described in the context of aircraft manufacturing and service method 900 as shown in FIG. 9 and aircraft 1000 as shown in FIG. 10. Turning first to FIG. 9, an illustration of an aircraft manufacturing and service method in a form of a block diagram is depicted in accordance with an illustrative embodiment. During pre-production, aircraft manufacturing and service method 900 may include specification and design 902 of aircraft 1000 in FIG. 10 and material procurement 904.

During production, component and subassembly manufacturing 906 and system integration 908 of aircraft 1000 takes place. Thereafter, aircraft 1000 may go through certification and delivery 910 in order to be placed in service 912. While in service 912 by a customer, aircraft 1000 is scheduled for routine maintenance and service 914, which may include modification, reconfiguration, refurbishment, or other maintenance and service.

Each of the processes of aircraft manufacturing and service method 900 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 10, an illustration of an aircraft in a form of a block diagram is depicted in which an illustrative embodiment may be implemented. In this example, aircraft 1000 is produced by aircraft manufacturing and service method 900 of FIG. 9 and may include airframe 1002 with plurality of systems 1004 and interior 1006. Examples of systems 1004 include one or more of propulsion system 1008, electrical system 1010, hydraulic system 1012, and environmental system 1014. Any number of other systems may be included.

Apparatuses and methods embodied herein may be employed during at least one of the stages of aircraft manufacturing and service method 900. One or more illustrative embodiments may be manufactured or used during at least one of component and subassembly manufacturing 906, system integration 908, in service 912, or maintenance and service 914 of FIG. 9.

The illustrative examples present a movable carriage and methods for wrapping a material sheet around a longitudinal component. In some illustrative examples, the movable carriage can be referred to as a zipper mechanism. The movable carriage comprises angled wheels that pull up a material sheet to wrap around bladder. The wheels are sufficiently compliant to pull the material sheet. The movable carriage comprises a frame that houses the angled wheels that form the zipper mechanism. In some illustrative examples, the frame of the movable carriage provides adjustability in horizontal and vertical positioning of the wheels.

In some illustrative examples, the angled wheels passively roll as the movable carriage moves along the longitudinal component.

To wrap the material sheet around the longitudinal component, the movable carriage is moved along the length of the longitudinal component. The angled wheels are in contact with the material sheet as the movable carriage moves along the longitudinal.

The angled wheels guide and tighten the material into place as the angled wheels roll. Angles of the angled wheels can be adjusted based on the design of the longitudinal component, type of material sheet, and other characteristics.

In some illustrative examples, springs push the angled wheels against the surface of the longitudinal component. In these illustrative examples, the springs provide normal/friction forces to move the material sheet.

In some illustrative examples, the movable carriage features several opposed pairs of spring-biased wheels disposed at angles configured to frictionally guide and tighten a material sheet around and against the exterior surfaces of the longitudinal component, such as an inflatable bladder. In some illustrative examples, the movable carriage is adjustable to the longitudinal component. In some illustrative examples, right and left hand lead screw are provided for symmetric guides adjustment around the longitudinal component.

The movable carriage reduces the time to wrap the material sheet around the longitudinal component. The movable carriage can reduce the time to wrap the material sheet around the longitudinal component from multiple hours to less than an hour.

In some illustrative examples, the movable carriage can ride along an optional rail system. An optional rail system can guide the direction of movement of the movable carriage. In some illustrative examples, the movable carriage can be motorized on the rail. The optional rail system can have a length scaled for different sized longitudinal components.

The movable carriage can save manufacturing space in comparison to stationary systems. By moving movable carriage along the longitudinal component, the footprint for the wrapping system can be half the length of a stationary system. The movable carriage slides along the longitudinal component, saving space in comparison to sliding a longitudinal component through a system.

In some illustrative examples, a longitudinal component can be placed on a worktable. In some illustrative examples, the longitudinal component is placed on a material sheet on the worktable. In some illustrative examples, the longitudinal component can take the form of a bladder. The bladder is made substantially rigid prior to wrapping the material sheet around the longitudinal component. In some illustrative examples, the bladder is filled with air to cause the longitudinal component to be substantially rigid.

In some illustrative examples, the material sheet is loaded and fed to the movable carriage. The movable carriage is moved along the longitudinal component to fold the material sheet around the longitudinal component. The material sheet is taped to the longitudinal component and excess material sheet is cut off at the end of the longitudinal component. The wrapped longitudinal component is removed from the work table. In some illustrative examples, multiple carriages can be linked together to provide multiple layers of wrap in one pass.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A movable carriage configured to wrap a material sheet around a longitudinal component, the movable carriage comprising:
a frame defining a center plane and an operating volume;
side wheels within the operating volume configured to guide the material sheet against sides of a portion of the longitudinal component, when disposed within the operating volume and aligned with the center plane, as the movable carriage moves parallel to the center plane, the side wheels arranged as one or more opposing pairs about the center plane; and
top wheels within the operating volume configured to guide the material sheet against a top of the portion of the longitudinal component as the movable carriage moves parallel to the center plane, the top wheels arranged as one or more opposing pairs about the center plane.

2. (canceled)

3. The movable carriage of claim 1, wherein at least one of the side wheels or the top wheels are spring loaded.

4. The movable carriage of claim 1 further comprising:
springs arranged in spring pairs, wherein each spring pair of the spring pairs is connected to a respective wheel of one of top wheels or side wheels.

5. The movable carriage of claim 4, wherein each spring pair has two different stiffnesses.

6. The movable carriage of claim 1 further comprising:
a number of positioning plates comprising at least one of side positioning plates connecting the side wheels to sides of the frame at an angle configured to engage sides of the longitudinal component or top positioning plates connecting the top wheels to the frame and configured to place top wheels normal to a cross-sectional shape of the longitudinal component.

7. The movable carriage of claim 1, wherein the top wheels comprise a first top wheel pair positioned at a first angle relative to the center plane.

8. The movable carriage of claim 7, wherein the top wheels comprise a second top wheel pair positioned at a second angle relative to the center plane, wherein the second angle is greater than the first angle.

9. (canceled)

10. The movable carriage of claim 1, wherein the side wheels and the top wheels are facing into the operating volume.

11. The movable carriage of claim 1 further comprising:
a movement system connected to the frame and configured to move the movable carriage in a direction parallel to the center plane.

12. (canceled)

13. The movable carriage of claim 11, wherein the movement system comprises a motor configured to at least partially drive the movable carriage parallel to the center plane.

14-15. (canceled)

16. The movable carriage of claim 1, wherein the side wheels and top wheels are formed of a material having a coefficient of friction with the material sheet sufficient to guide the material sheet around the longitudinal component.

17. A movable carriage configured to wrap a material sheet around a longitudinal component, the movable carriage comprising:
a frame defining a center plane and an operating volume;
a plurality of wheels within the operating volume arranged as a plurality of stages offset from each other along the center plane of the frame, wherein angles of wheels of each respective stage of the plurality of stages increase along the center plane; and
a number of positioning plates connected to the frame and holding the plurality of wheels normal to a cross-sectional shape of the longitudinal component.

18. The movable carriage of claim 17, wherein the number of positioning plates is adjustable and configured to adjust a position of the plurality of wheels within the operating volume.

19. The movable carriage of claim 17, wherein the plurality of wheels is spring-loaded.

20-28. (canceled)

29. A method of wrapping a material sheet around a longitudinal component, the method comprising:
positioning a movable carriage such that a longitudinal component is within an operating volume beneath a frame of the movable carriage;
moving the movable carriage in a direction parallel to a longitudinal axis of the longitudinal component; and
guiding the material sheet around the longitudinal component using wheels of the movable carriage within the operating volume as the movable carriage moves in the direction.

30. The method of claim 29, wherein moving the movable carriage comprises moving the movable carriage along a track system of a work table supporting the longitudinal component.

31. The method of claim 29, wherein guiding the material sheet around the longitudinal component using the wheels comprises:
guiding the material sheet onto sides of the longitudinal component using side wheels connected to sides of the frame and arranged as opposing pairs about a center plane defined by the frame; and
guiding the material sheet onto a top of the longitudinal component using top wheels connected to a top of the frame and arranged as opposing pairs about the center plane.

32. The method of claim 29, wherein guiding the material sheet around the longitudinal component using wheels of the movable carriage within the operating volume as the movable carriage moves in the direction comprises sequentially contacting the material sheet with opposing pairs of wheels at increasing angles relative to the direction.

33. The method of claim 29, wherein moving the movable carriage comprises at least partially powering movement of the movable carriage using a motor.

34. The method of claim 29, wherein guiding the material sheet around the longitudinal component comprises passively driving the wheels by the moving of the movable carriage in the direction.
